(19) United States
(12) Patent Application Publication
(10) Pub. No.: US 2002/0034305 A1
(43) Pub. Date: Mar. 21, 2002

(54) Method and system for issuing service and method and system for providing service

(76) Inventors: Hideo Noyama, Sagamihara (JP); Mitsuhiro Hirano, Yokohama (JP); Shuji Terada, Kawasaki (JP); Takeshi Matsuki, Musashino (JP); Mitsuru Iwamura, Tokyo (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/908,719

(22) Filed: Jul. 20, 2001

(30) Foreign Application Priority Data
Jul. 21, 2000 (JP) 2000-226185

(51) Int. Cl. H04L 9/00

(52) U.S. Cl. 380/282; 713/185

(57) ABSTRACT

According to the present invention, a service issuing system 1110 comprises identification number issuing means 1120 for issuing an identification number 1130 required to receive a service in accordance with an application from a user system 1210, encryption means 1150 for encrypting the identification number 1130 and generating encrypted data 1160 by a private key 1140 corresponding to a public key owned by a service provider, and encryption means 1170 for encrypting the encrypted data 1160 and generating encrypted data 1180 by an encryption key 1240 corresponding to a decryption key owned by the user system 1210.

### BACKGROUND OF THE INVENTION

The present invention relates to a service issuing method and system for issuing to the user the identification (ID) information required for the user to be provided with a service and a service providing method and system for determining whether the user can be provided with the service or not.

According to the prior art disclosed by JP-A11-239129, in the case where the contents purchased by the purchaser are encrypted by the public key of the purchaser and sent to the purchaser and utilized (decrypted) by the purchaser, an electronic signature is prepared using the private key of the purchaser himself and embedded in the contents as an electronic watermark. In the event that an illegal copy is found, the purchaser can be identified by detecting the electronic signature.

JP-A-11-261550, on the other hand, discloses a method in which features are extracted from an electronic document to prepare feature data, which are encrypted by the encryption key of the party involved, and by attaching the authentication data such as the date, the encrypted data are further encrypted by the encryption key of an external authenticator. In this way, even the party involved cannot alter the document thereby to promote the computerization of the documents.

In the invention described in JP-A-11-239129, an electronic signature is prepared by use of the private key of the purchaser himself and embedded as an electronic watermark in the contents so that the purchaser who has produced an illegal copy can be identified. However, the electronic watermark, which can be embedded in such contents as an image or music, cannot be easily embedded in the data having a smaller redundancy. Also, the fact that the data in which the electronic signature of the purchaser is embedded is large in size is tantamount to the need of a recording medium of a corresponding size for storing the particular data.

The electronic signature described in the invention of JP-A-11-239129 is the information by which a third party organization or the distributor of the contents may identify the purchaser. Nevertheless, the purchaser cannot be identified with the electronic signature alone. Specifically, regardless of the information contained in the electronic signature, the third party organization or the contents distributor identifies the purchaser by collating the watermark data detected from the contents with a data base for managing the purchaser information. Therefore, the data base is essential for the place of identifying the purchaser. In other words, the place utilizing the prior art is limited to where the data base of the purchaser can be managed and installed or where the data base is accessible by a network.

The invention described in JP-A-11-261550, on the other hand, is intended to prevent the alteration of an electronic document even by the very person who has prepared the document, by encrypting the electronic document with the public key of an external authenticator. This presupposes the external authenticator as the only organization high in reliability. In other words, the legitimacy of the electronic document is substantiated based on the assumed legitimacy of the authenticator thereby to give credit to the person who has prepared the document. Therefore, this system cannot be introduced for applications involving a multiplicity of places of authentication such as ordinary shops and entrance gates not considered high in security.

### SUMMARY OF THE INVENTION

An object of the present invention is to provide a service issuing method and a service providing method and systems therefor, in which the user can be identified without using a special recording medium by embedding the information for identifying the user in the data having a small redundancy.

Another object of the present invention is to provide a service issuing method and a service providing method and systems therefor, in which whether the identity and the right of the user are legitimate or not can be determined even in a place of use where the data base of the user or a sufficient network environment cannot be established.

Still another object of the invention is to provide a service issuing method and a service providing method and systems therefor, in which even a shop or the like low in reliability can be utilized as a place where transactions can be substantiated positively, by suppressing the illegal act at the place of use.

According to the present invention, there is provided a service issuing method in which the ID information required for the user to receive the service in accordance with an application is generated, the ID information is encrypted by a first encryption key corresponding to a first decryption key owned by the service provider, and the encrypted ID information is encrypted again by a second encryption key corresponding to a second decryption key owned by the user.

According to the present invention, there is provided a service providing system, in which a first decryption key owned by the service provider and first ID information required for receiving the service are stored in a storage medium in advance, second ID information required for receiving the service and a second decryption key owned by the user are acquired from the user, second ID information is decrypted by a second decryption key, the decrypted second ID information is encrypted again by the first decryption key, and the second ID information encrypted again is compared with the first ID information.

### BRIEF DESCRIPTION OF THE DRAWINGS

FIG. 1 is a flowchart of the process for a service issuer system and user system according to the invention.

FIGS. 2A to 2C are diagrams showing a data structure of a medium for storing the encryption data according to the invention.

FIGS. 3A and 3B are diagrams showing a system configuration of a service issuer system and a service provider according to the invention.

FIGS. 4A to 4C are diagrams showing an internal configuration of a service issuer system according to the invention.

FIG. 5 is a processing flowchart for legitimacy verification in a service provider system and a user system according to the invention.

FIG. 6 is a diagram showing a configuration of a concert ticket issuing system as an example of application of the invention to a ticket issuing system.

FIG. 7 is a flowchart showing a detailed process flow for an example of the application of the invention to a concert ticket issuing system.

FIG. 8 is a diagram showing a system configuration for issuing a traveler's check as an example of application of the invention to a traveler's check or an ordinary check.

FIG. 9 is a flowchart showing the process for issuing a traveler's check as an example of application of the invention to a traveler's check or an ordinary check.

FIGS. 10A to 10C are diagrams for explaining the information and the arrangement of the information described in an ordinary check as an example of application of the invention to a traveler's check or an ordinary check.

FIG. 11 is a diagram showing a configuration of a system for receiving a layaway service for packages delivered door-to-door by trucking as an example of application of the invention to the layaway service.

FIG. 12 is a flowchart showing a detailed process flow as an example of application of the invention to the layaway service of packages delivered door-to-door by trucking.

### DETAILED DESCRIPTION OF THE EMBODIMENTS

Embodiments of the present invention will be explained below.

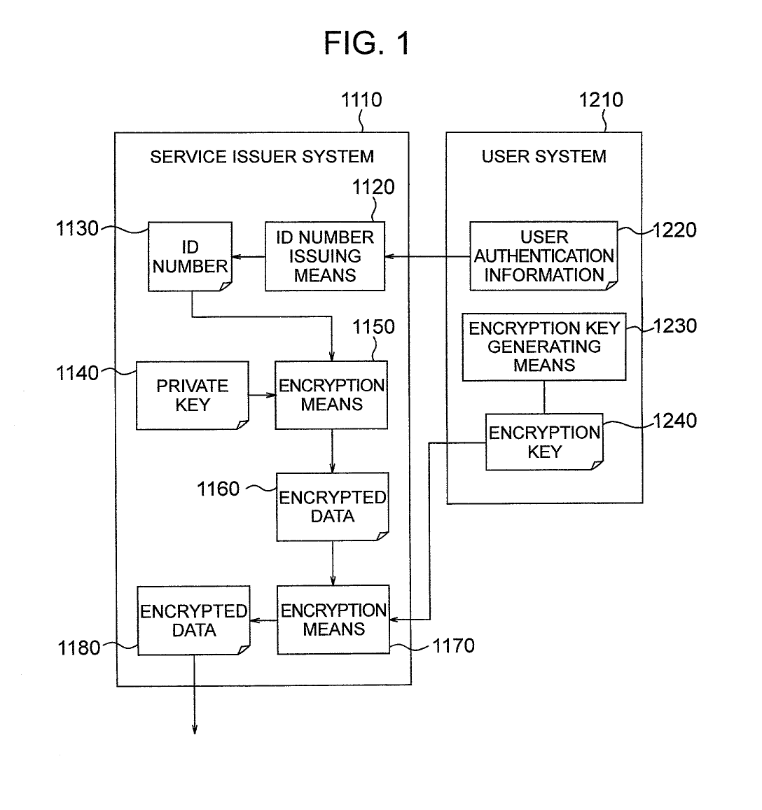

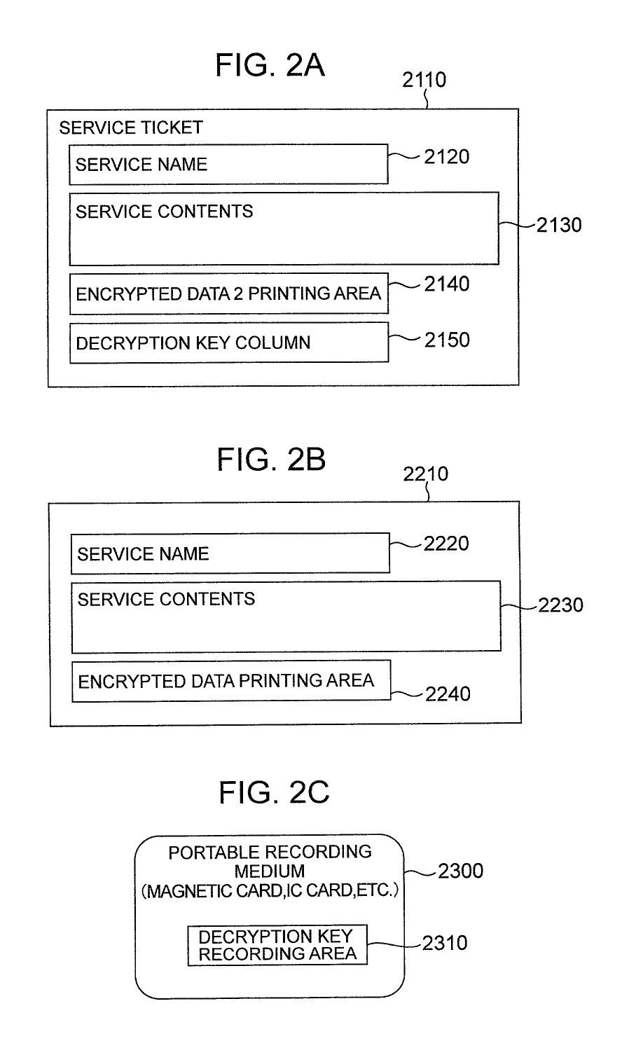

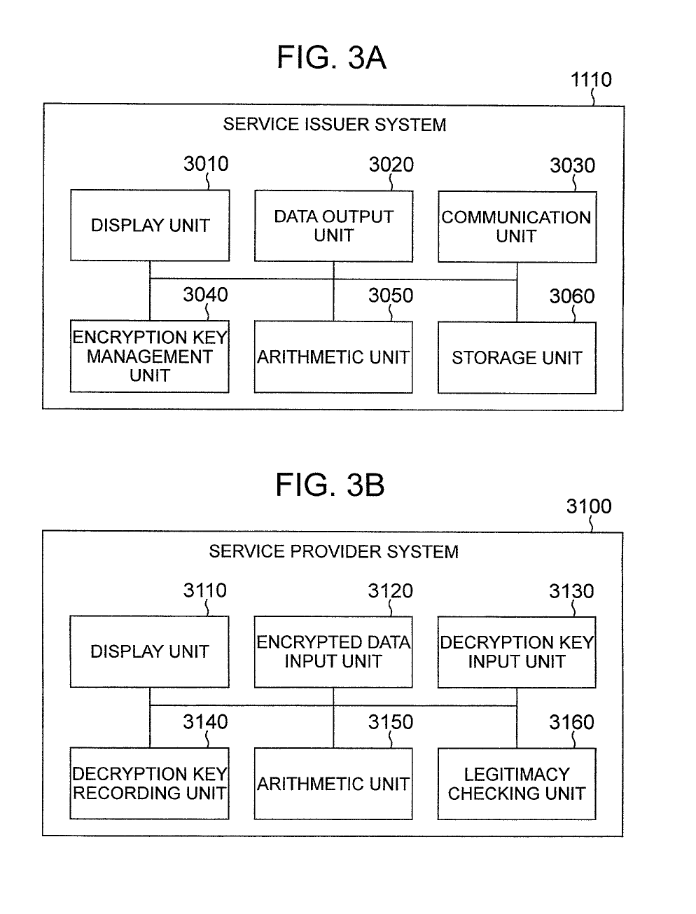

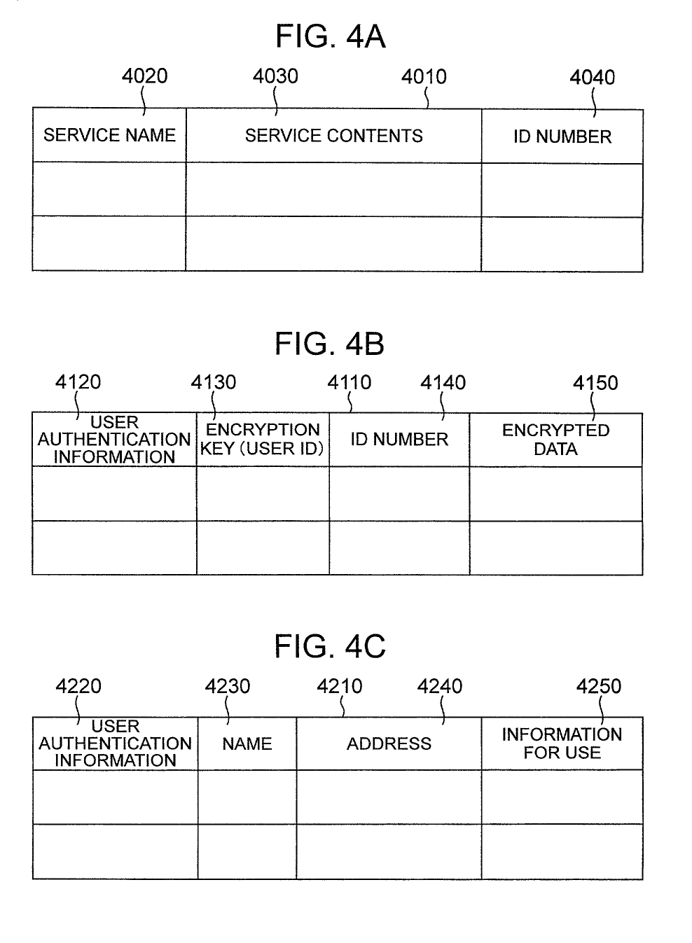

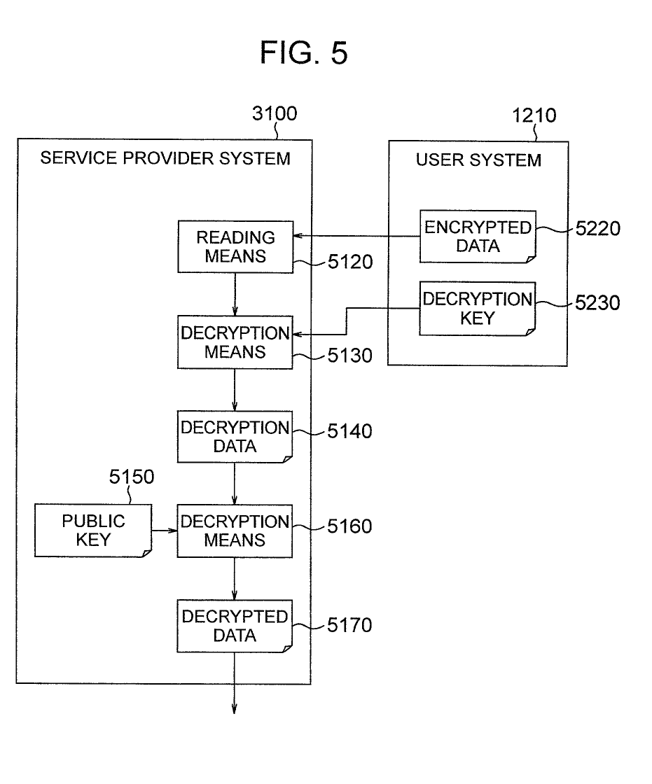

FIG. 1 shows a process flow of a service issuer system and a user system according to the invention. FIGS. 2A to 2C are diagrams showing a data structure of a medium for storing the encrypted data according to the invention. FIGS. 3A and 3B are diagrams showing a configuration of a service issuer system and a service provider system according to the invention. FIGS. 4A to 4C are diagrams showing a configuration of the internal tables of a service issuer system according to the invention. A storage unit 3060 shown in FIGS. 3A and 3B has a data base including this table. FIG. 5 shows a process flow for legitimacy verification for a service provider system and a user system. The encrypted data are defined as data encrypted by an encryption key. The decrypted data are defined as data decrypted by a decryption key.

The participants according to the invention are defined as a user utilizing the service (provided with the service), a service provider providing the service to the user at a place where the service is actually utilized, and a service issuer who issues the ID information required for the user to receive the service. The service issuer and the service provider may be located at places physically distant from each other. Take the concert ticket, for example. The service issuer is a business entity who issues and sells the ticket, and the service provider is a concert management company which recovers the ticket at the place where the concert is held. These two participants are normally organizations (companies) independent of each other. The ticket is a medium that connects the two participants. In the case where the ticket is forged, therefore, the service provider has no means of rejecting the illegal user. In order that only the user in agreement with the service issuer may be provided with the service from the service provider, the present invention utilizes the following encryption processing. The service issuer and the service provider may be the same business entity.

A service issuer system 1110 is a system (computer or the like) used by the service issuer. The service issuer system 1110 comprises a display unit (such as a CRT or a liquid crystal display) 3010 for displaying information, a data output unit (such as a printer) 3020 for outputting data, a communication unit (such as a modem, a terminal adaptor or a LAN card) 3030 for effecting communication with other devices through a network or the like, an encryption key managing unit 3040 for managing the encryption key, an arithmetic unit (such as a CPU) 3050 for performing the arithmetic operation for executing various processes, and a storage unit (such as a hard disk unit) 3060 for storing data. The service issuer system 1110 performs various processes by executing a program through the arithmetic unit 3050.

A service provider system 3100 is a system (such as a computer) used by the service provider. The service provider system 3100 comprises a display unit (such as a CRT or a liquid crystal display) 3110 for displaying information, a data output unit (such as a printer) 3120 for outputting data, a decryption key input unit 3130 for receiving the input of a decryption key, a decryption key storage unit (such as a hard disk unit) 3140 for storing a decryption key, an arithmetic unit (such as a CPU) 3150 for performing the arithmetic operation for executing various processes, and a legitimacy checking unit 3160 for checking the legitimacy of the user identity. The legitimacy checking unit 3160 may be implemented by software.

A user system 1210 is a system (such as a computer) utilized by the user. The user system 1210 comprises a display unit (such as a CRT or a liquid crystal display) for displaying information, an arithmetic unit (such as a CPU) for performing the arithmetic operation for executing various processes, and a storage unit for storing the data required for the arithmetic operation, the data obtained from the result of the arithmetic operation and the programs for executing the various processes.

The user system 1210 files a service application to the service issuer system 1110. At the same time, the user system 1210 transmits the user authentication information 1220 as his information. The user authentication information is an identifier supplied by the service issuer system 1110 to the user system 1210 in advance, and is preferably a combination of a user ID and a password. The user authentication information is managed by a table 4210 stored in the storage unit 3060 in association with the utilization information 4250 including the user name 4230, the user address 4240 and the type of the service used and frequency at which the service is used.

The user system 1210 has encryption key generating means 1230, by use of which an encryption key 1240 is produced. This encryption key 1240 has a value accessible only by the user and is produced by the user himself or a value such as a password.

The service issuer system 1110 generates an ID number 1130 for discriminating the contents of the service through the ID number issuing means 1120. This operation is represented by the job of assigning a unique serial number to the concert ticket described above, for example.

The private key 1140 prepared by the public key encryption method is held in the encryption key management unit 3040 of the service issuer system. The encryption means 1150 encrypts the the ID number with the private key 1140. The data prepared by the encryption is assumed to be the encrypted data 1160. In the service issuer system 1110, the encrypted data 1160 is encrypted again with the encryption key 1240 of the user through the encryption means 1170. The encryption means 1170 is a function which is supplied with the encryption key 1240 and the encryption value and outputs the encrypted data, and is not what is generally called the encryption processing. The data prepared by this encryption is assumed to be the encrypted data 1180. These numerical processing is performed in the arithmetic unit 3050, which is preferably a high-speed CPU.

The encryption key 1240 is transmitted from the user system 1210 to the service issuer system in compliance with the request of the encryption means 1180. The encrypted data 1180 prepared by the service issuer system 1110 is output from the data output unit 3020 of the service issuer system 1110, and stored in such a medium as a paper ticket 2110, a magnetic card or an IC card as shown in FIGS. 2A to 2C.

FIG. 2A shows a layout of data printed on a service ticket in the case where a storage medium of paper is used for the encrypted data 1180. The service ticket 2110 is printed with at least a service name 2120 which indicates the service contents in brief words and the service contents 2130 describing the service contents and the date and place at which the service is provided. According to this invention, the encrypted data 1180 prepared by the service issuer system 1110 is printed in a printing area 2140 of the encrypted data. The encrypted data 1180 is described as a numeral and/or character string data (symbol string data) in the encrypted data printing area 2140. This data can alternatively described after being converted to a bar code or a two-dimensional code. The advantage of using this code is that a multi-purpose reader can construct the service provider system 3100 at low cost. The two-dimensional code includes a stack type with bar codes stacked and a matrix type with cells of the same size arranged laterally and longitudinally in black and white. The representative two-dimensional codes are the QR code developed by Denso, the data matrix developed by I.D. Matrix and PDF417 developed by Symbol Technology. The decryption key column 2150 is an area filled by the user immediately before delivering the service ticket to the service provider. The service issuer prints the service ticket with the decryption key column 2150 left vacant. The decryption key column 2150, however, may be of mark sheet type, in which case the service ticket becomes usable by smearing out the mark sheet before being used.

FIGS. 2B and 2C show a layout of the data printed on the service ticket in the case where the paper service ticket 2210 and the portable recording medium 2300 owned by the user are used in combination. In this case, the decryption key 5230 is recorded in the decryption key recording area 2310 of the portable recording medium 2300 such as a magnetic card or an IC card. Therefore, the data in other than the decryption key column 2150, i.e. the service name 2200, the service contents 2230 and the encrypted data printing area 2240 are printed in the service ticket 2210.

According to this embodiment, what is called the paper ticket or the cybernetic ticket (paper with magnetic material attached on the back) is used as a service ticket. The invention is not limited, however, to what is called the paper ticket, and a magnetic card or an IC card which can store the data shown in FIGS. 2A to 2C or a portable information terminal such as a portable telephone can alternatively be used with equal effect.

The tables shown in FIGS. 4A to 4C will be explained. Tables 4010, 4110, 4210 represent the data base constructed in the storage unit 3060 of the service issuer system 1110. Specifically, the table 4010 defines each service provided by the service provider, the table 4210 is used for management of the user, and the table 4110 connects the user and the service to each other.

The table 4010 includes at least such elements as a service name 4020 for indicating the service in a word, service contents 4030 describing the specifics of the service and a unique ID number 4040 for identifying the service. The table 4210 includes elements including user authentication information 4220 assigned to the user, a user name 4230, a user address 4240 and user information 4250 such as the frequency of use. The contents described in the table 4210 for managing the user, however, are not limited to the name, address or the like information but may be any means by which the user can be contacted. The electronic mail, for example, makes it possible to contact the user even if anonymous. The table 4110 is the one for connecting the user and the service to each other. Specifically, the table 4110 is configured of a user ID 4120, an encryption key 4130, an ID number 4140 and encrypted data 4150. According to this invention, the table 4110 is not basically required. In providing actual services, however, the user may lose the service ticket or the encryption key, in which case the reissue or the like process cannot be carried out without this table. Therefore, this table is required as a user support function.

Now, FIG. 5 will be explained. FIG. 5 shows a basic flow of the process for evidencing that the user is the owner of the encrypted data by the legitimacy checking unit 3160 of the service provider system 3100.

The service issuing system 1110 provides the service provider system 3100 with the table 4010. The service provider system 3100 has the table 4010 stored in the storage unit. The user system 1210 stores a decryption key 5230 paired with the encryption key 1240, and moves it to the portable storage medium 2300. The encrypted data 5220 is recorded in the service ticket 2110 or 2210 and conveniently carried by the user. In the service provider system 3100, the encrypted data reading means 5120 of the encrypted data input unit 3120 reads the encrypted data 5220 recorded in the recording medium such as the service ticket 2110. In the process, a multi-purpose reader can be used as the reading means 5120 in the case where the data is a bar code or a two-dimensional code.

Then, the decryption key 5230 is read by the decryption means 15130 of the decryption key input unit 3130, and the encrypted data 5220 is decrypted by the decryption key. In the process, the decrypted data 5140 make up the encrypted data 1160. This decryption key is temporarily stored in the decryption key recording device 3140. Then, in the decryption means 5160, the decrypted data 5140 is decrypted with the public key 5150 of the service issuer. In the process, the decrypted data 5170 makes up the ID number 1130. Further, in the service provider system 3100 with the table 4010 recorded therein, the legitimacy checking unit 3160 compares the ID number 1130 with the ID number 4040 of the table 4010 and determines whether the same value as the ID number 1130 exists in the column where the ID number 4040 of the table 4010 is recorded. In the case where the same value so exists, the user can be determined as legitimate. Also, in this case, the service name 4020 and the service contents 4040 can be specified from the ID number 4040. The service name 4020 and the service contents 4030 are displayed as the result of comparison (result of determination) on the display unit 3110 of the service provider system 3100. In the case where the ID number is described in the ticket 2110, however, the legitimacy of the user can be determined without the table 4010. The ID number is not required to be described directly in the ticket 2110, but may be described in the encrypted data printing area 2140 together with the encrypted data (with a character string, for example). The process described above is executed in the arithmetic unit 3150.

In this embodiment, a personal computer, a workstation or the like is used as the service issuer system, the service provider system and the user system. The functions of the various means described above can be implemented by the program executed on these computers. Especially, the computer of the user, which has storage means, display/input means and communication means, may be a multi-purpose portable terminal capable of carrying a program or what is called the portable telephone, and is not limited to a computer system.

Further, in view of the fact that the encryption key 1240 and the decryption key 5230 are held by the user, the user system can decrypt the encrypted data (only to obtain the encrypted data 1). Specifically, the service issuer system is required to use an encryption method incapable of being decrypted by the user system. Concretely, the encryption key is formed as a password of several digits and the arithmetic operation (adding the password to the encrypted data 1160, for example) in the encryption means 1170 is kept private. By so doing, it is difficult for the user to decrypt the encrypted data 1180 even the user is in the knowledge of the password constituting the decryption key.

Also, in the embodiments described above, a program is installed beforehand in the user system 1210. Specifically, the service cannot be received unless a special program is installed in the user system 1210 for the inconvenience of the participants. The install work is not required, however, if the process corresponding to a special program is packaged as Java Applet utilizing the technique such as Java and the same Applet can be downloaded from the service issuer system 1110. In almost all the computers connected to the network, a multi-purpose browser is installed, and therefore the use of the Java technique eliminates the need of imposing a special burden on the user.

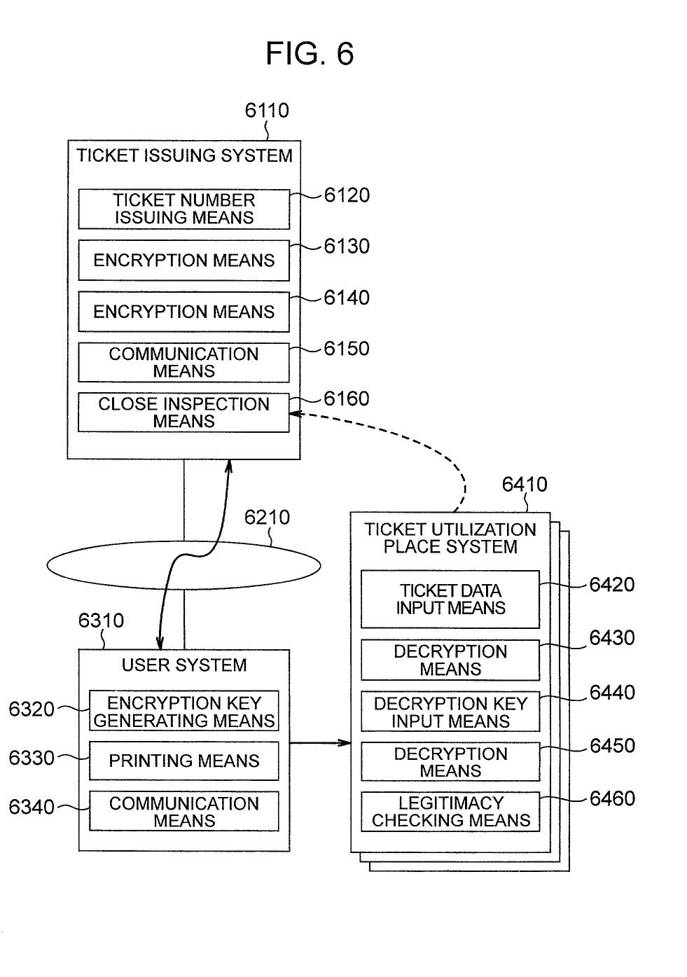

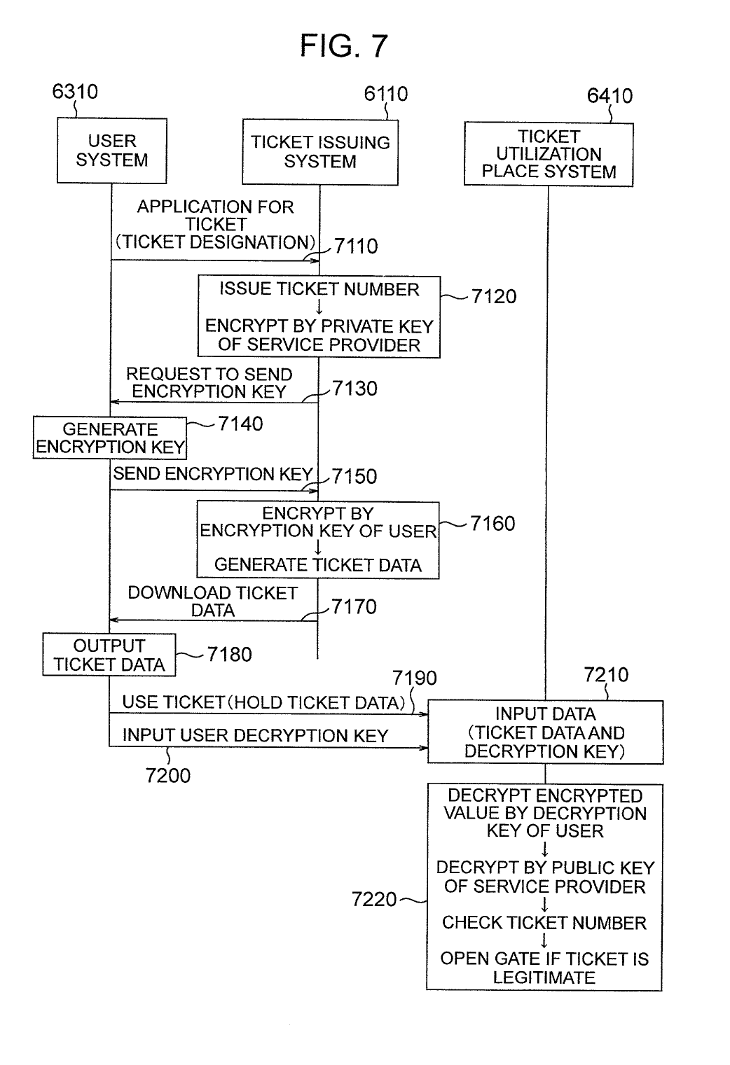

FIGS. 6 and 7 show an example in which the invention is used for a concert ticket issuing system. FIG. 6 shows a configuration of the ticket issuing system, and FIG. 7 a flowchart showing the flow of the process.

A ticket issuing system 6110 receives an application for the concert ticket from the user system 6310 in step 7110. Specifically, the concert name and the date when the concert is held are input from the user system 6310 thereby to select the type of ticket.

Then, the ticket issuing system 6110 assigns a unique management number (hereinafter referred to as the ticket number) for each ticket by the ticket number issuing means 6120. The ticket number may contain the concert information or the purchaser information. In the case where the purchaser information is contained, the participants involved can be identified in case of illegal duplication of the ticket.

Then, the ticket number is encrypted with the private key of the service provider by the encryption means 6130. This process is performed in step 7120, and the output of step 7120 is used as encrypted data. In step 7130, the ticket issuing system 6110 issues a request to send the encryption key of the user.

The encryption key generating means 6320 of the user system, on the other hand, prepares the encryption key in step 7140, and transmits the encryption key to the ticket issuing system 6110 in step 7150. As described above, this encryption key may be an encryption key of the public key cryptography or an encryption key of the common key cryptosystem or a combination of a lock with a private encryption/decryption system and a password.

The ticket issuing system 6110 encrypts the encrypted data again with the encryption key in the encryption means 26140 (step 7160). This output is assumed to be the encrypted data. In step 7160, on the other hand, the data having the structure shown in the service ticket 2110 is prepared using the encrypted data and transmitted to the user system 6310 as ticket data (step 7170).

The data transmission and reception described above are carried out by the communication means 6150 of the ticket issuing system 6110 and the communication means 6340 of the user system 6310 through the network 6210. The network 6210 may be a network such as an internet, a public telephone line, a radio communication network or any combination thereof, and the type and scale of the network are not limited.

The user system 6310 outputs the ticket data from the printing means 6330 in step 7180. Specifically, the ticket data is prepared as image data in step 7160, and this image data is printed to form a concert ticket.

A ticket utilization place system 6410, on the other hand, is an authentication system installed in the place where the concert is held. The ticket data is input by the ticket data input means 6420, and the user decryption key is input by the decryption key input means 6440 (step 7210). Further, in step 7220, the encrypted data is decrypted with the decryption key of the user by the decryption means 6430, and decrypted with the public key of the service provider by the decryption means 6450. Assume that the result of decryption is called the decrypted data. In the case where the decrypted data coincides with the ticket number recorded on the paper, the ticket utilization place system 6410 can determine that the ticket is legitimate and therefore the entrance gate for the concert can be opened.

In the prior art, it has been common practice to purchase the concert ticket directly at a ticket agent or receive by mail based on the reservation made on the internet. The user, therefore, has taken the trouble of visiting the agent or has the ticket mailed, as the case may be. According to this invention, however, the ticket can be downloaded and printed by the user system 1210, and therefore the time and labor are saved for going to the agent or mailing. Another problem of ticket sale is how to settle the account. In the case where the user has a credit card or a bank account associated with the membership of a corresponding club, the ticket issuing system 6110 can issue a ticket while at the same time requesting a financial institution or the like to settle the account. In the case where the user is not a member of such a club, however, the electronic money or other means of settlement has to be used.

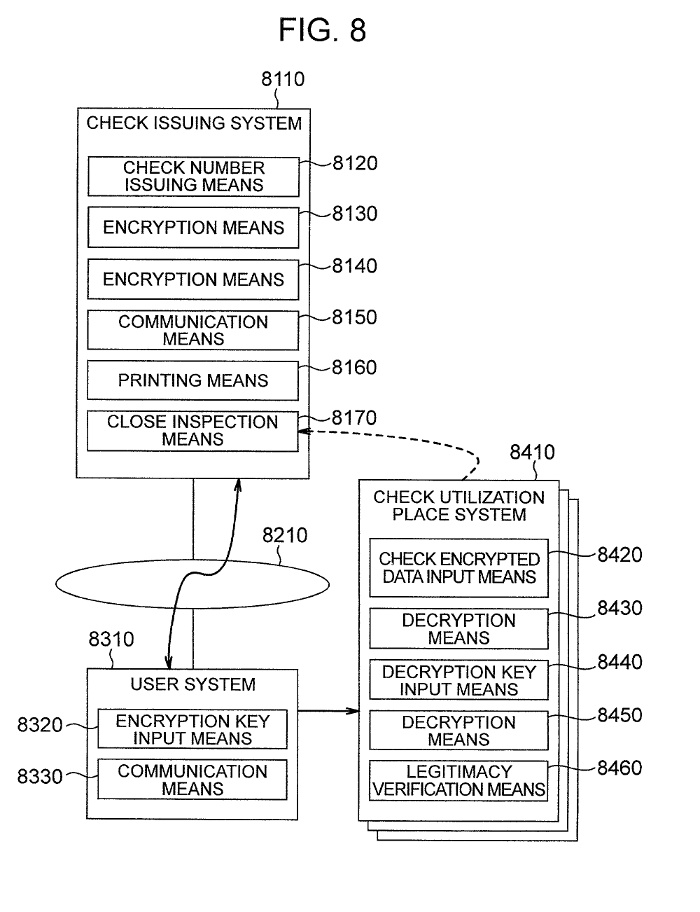

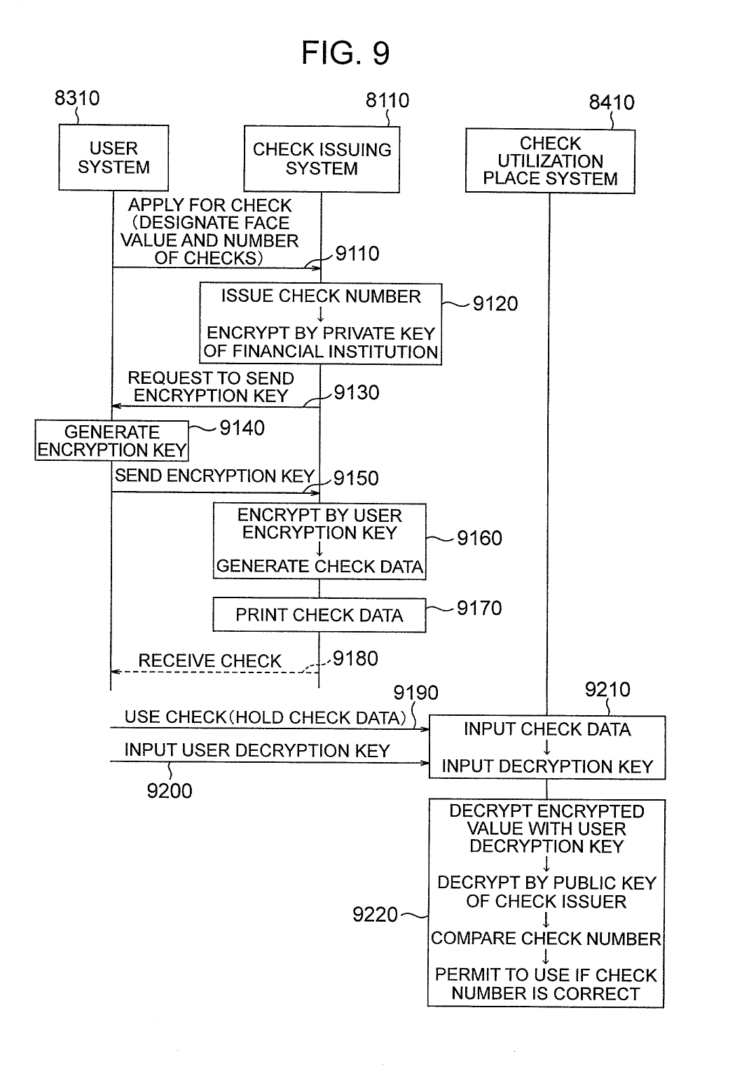

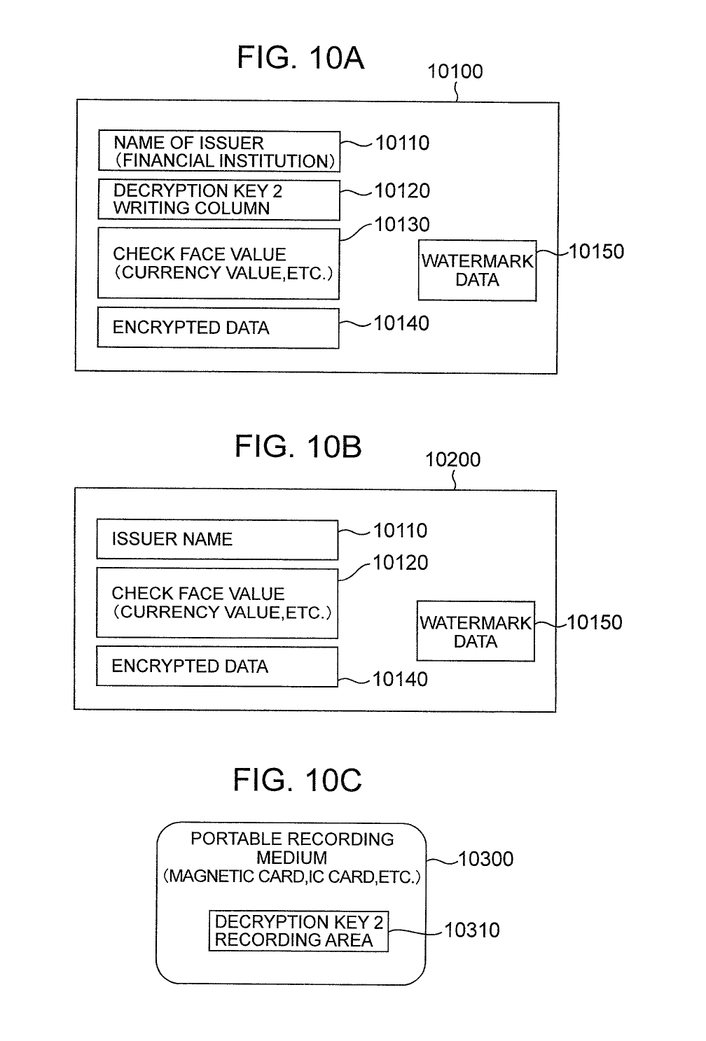

FIGS. 8 to 10A to 10C show an example of application of the invention to a traveler's check or an ordinary check (hereinafter referred to as the check or the like). FIG. 8 is a diagram showing a configuration of a system for issuing a ticket. FIG. 9 is a flowchart of the process for issuing a ticket, and FIGS. 10A to 10C diagrams for explaining the information described in the ticket or the like and the layout thereof.

In FIG. 8, the check issuing system 8110 is that of a financial institution, the check utilization place system 8410 is the one at the place (retail store, for example) where the ticket or the like is used by the user, and the user system 8310 is a consumer terminal.

First, the check issuing system 8110 receives an application for the ticket or the like from the user system 8310 (step 9110). At the same time, the type (face value) and the number of tickets or the like are designated, and based on this information, the check number issuing means 8120 issues the check management number (hereinafter referred to as the check number). The check number contains at least the number indicating the type of the check or the like and the number unique to each check or the like. Further, the encryption means 8130 encrypts the check number with the private key of the financial institution (step 9120). The check number thus encrypted makes up the encrypted data.

Then, the check issuing system requests the encryption key of the user to be sent in step 9130, and receives the encryption key of the user in step 9150. The encryption means 8140 encrypts the encrypted data with the encryption key of the user and thereby generates the encrypted data (step 9160). Also, the data of the check or the like 10100 or the check or the like 10200 shown in FIG. 10 is prepared using the encrypted data. Further, the check issuing system has printing means 8160 for printing the data of the check or the like 10100 or the check or the like 10200 in step 9170. Incidentally, the user acquires the check or the like by mail or by visiting the issuer financial institution.

The check or the like is printed with the issuer name 10110 such as the financial institution, the check type 10130 and the encrypted data 10140. Further, in order to prevent illegal duplication, the watermark data 10150 is embedded. The watermark data 10150 is the electronic data for identifying the purchaser, embedded for suppressing the illegal act. In the case of paper money or the like using special paper, however, the watermark 10150 is not an essential factor. Further, the check or the like 10100 has a decryption key column 10120, in which the decryption key is filled to make the check or the like usable in a shop. The decryption key, which may be filled in the column 10120, may alternatively be stored in the decryption key recording area 10310 of the portable recording medium 10300 such as a magnetic card or an IC card and presented to a shop when using the check or the like (input to the check utilization place system).

In the check utilization place system 8410, the encrypted data is input by the check encrypted data input means 8420 and the user decryption key by the decryption key input means 8440 (step 9210). The encrypted data 2 is decrypted by the decryption means 18430 thereby to generate the decrypted data. Further, the check utilization place system 8410 decrypts the decrypted data by the decryption means 8450 using the public key of the check issuing system. Assuming that this output constitutes decrypted data, the decrypted data contain the number indicating the type of the check, and as long as this number is correct, the legitimacy checking means 8460 determines that the check or the like is legitimate (step 9220).

In the last step, the check issuing system 8110 recovers the check or the like and the user decryption key, determines in the close inspection means 8170 whether the user decryption key recovered and the user encryption key used in the encryption means 2 are a right combination or not, and if so, pays the charge at the check utilization place.

According to this embodiment, the confidential information of the user are embedded in the check or the like in advance so that safety can be secured even in the absence of a signature. In other words, the check or the like can be delivered without cash registration, and therefore the service of the financial institution issuing the check can be improved at low cost.

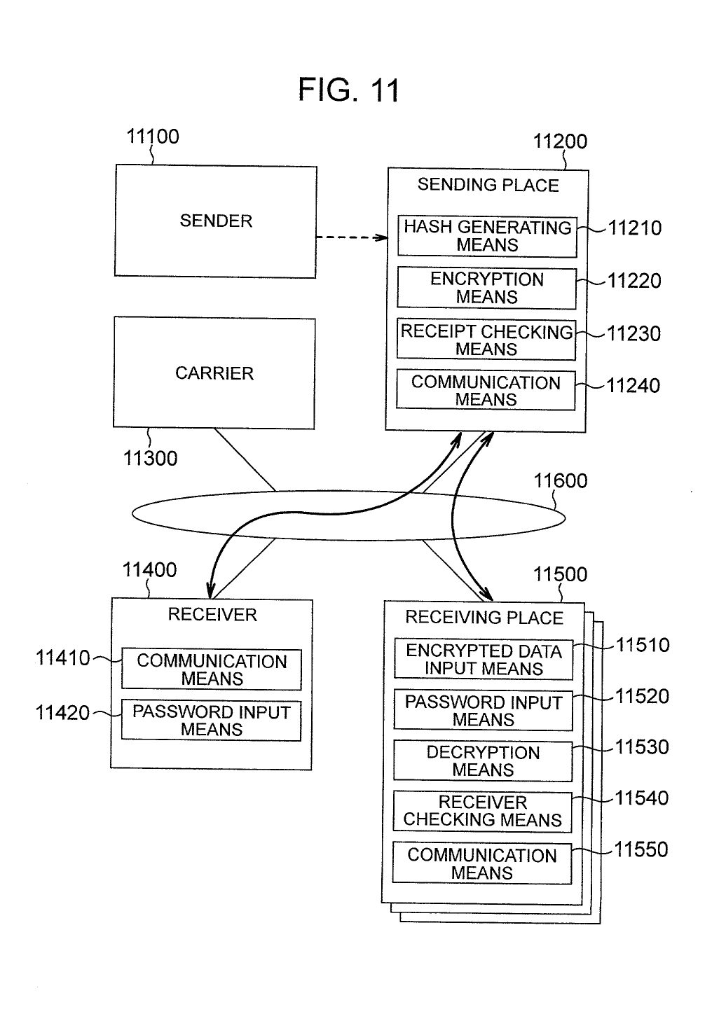

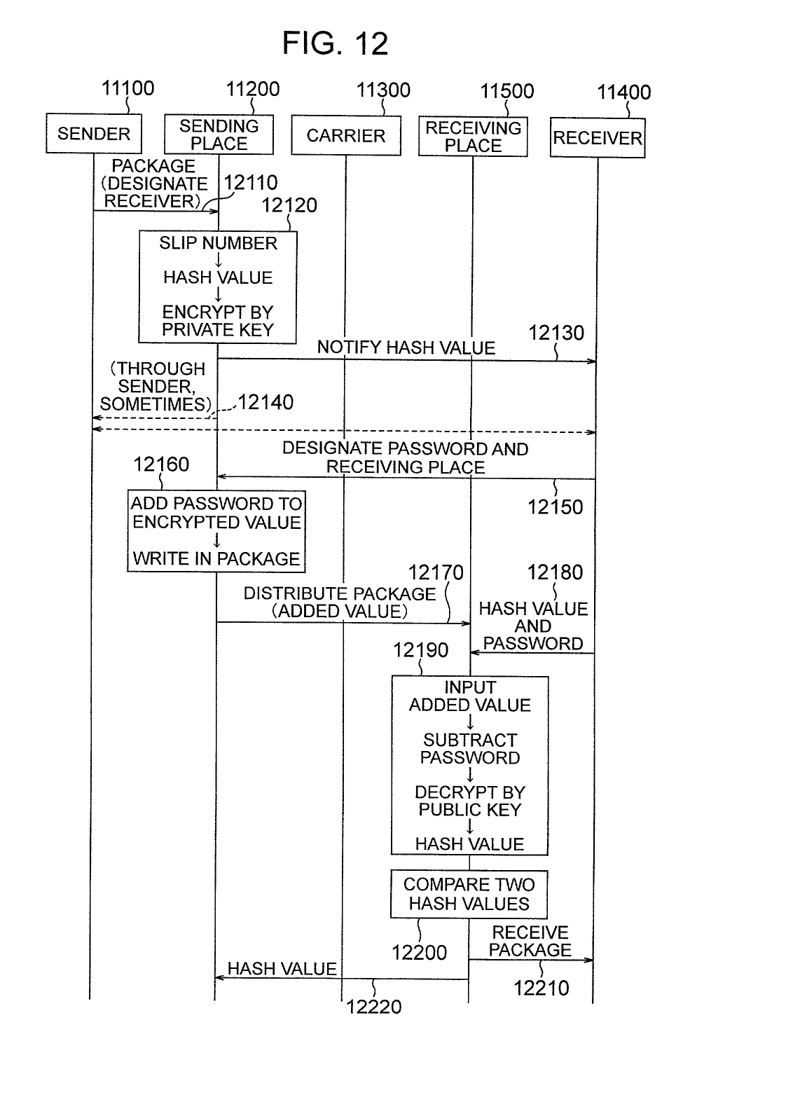

FIGS. 11 and 12 show an example of application of the invention to the registered mail, the door-to-door package delivery service or the information transmission.

The flowchart of FIG. 11 is designed to prevent the illegal act at the receiving place even in the case where the relation is tenuous between the receiving place and the sending place. Specifically, when the sender 11100 brings in a package and designates a receiver (step 12110), the sending place system 11200 generates a slip number in step 12120, generates a Hash value using the Hash function with the particular slip number, and further encrypting the Hash value with the private key of the sending place, generates a first encryption value. The Hash function is defined as an appropriate function for setting a character string in correspondence with a numerical value (Hash value). With the Hash function, a character string indicating a data item is set in correspondence with a numerical value. Thus, the Hash function is an irreversible one-way function.

In step 12130, the first encryption value is notified to the receiver 11400. The receiver sends the information on the receiving place and the password 1 in step 12150. This password is a value not related to the Hash value and desirably a value that can be easily memorized by the receiver.

The sending place system 11200 generates encrypted data to be described on a tag in step 12160. For example, the password is added to the first encryption value to generate a second encryption value, which is printed or stored on the tag. The arithmetic operation is not limited to the addition described in this case, but any function can be used as far as the input and the output are in one-to-one relation.

In step 12170, the second encryption value is transported to the receiving place together with the package. The receiving place system 11500 reads the encryption value from the tag of the package in step 12180, and after subtracting the password brought in by the receiver, decrypts the encryption value with the public key of the sending place. Assume that this is a decryption value. In step 12220, the Hash value and the decryption value are compared with each other, and in the case where the two values are coincident with each other, the prospective receiver is determined as a legitimate receiver, and the delivery of the package is permitted in step 12210. The sending place system 11200 may be a system used by a carrier for distributing the package or mail, a person to which the distribution is consigned, or an information processing system (including a personal computer, portable information terminal or a portable telephone) owned by the sender.

Further, the receiving place 11500 stores by encrypting the password input by the receiver, with the public key of the sending place, and in step 12220, sends the password to the sending place 11200 in place of a delivery bill of the package. The receiving place system 11500 has the public key of the sending place, but cannot correctly decrypt the data without the password. The sending place system 11200, therefore, can check that the package has been delivered to the receiver 11400, by recovering the password (including the process for decrypting the data with the private key). The receiving place system 11500 is a place (including a system) used or managed by the carrier or the person entrusted by the carrier.

The embodiment of the invention is also applicable to commodities.

According to this embodiment, what is required of the user is only to memorize the Hash value of a small number of digits and the password designated by himself. Unlike the one-time password, it is not necessary to use a different value each time, and the burden on the user is considered to be lighter. Further, in embodying the invention, a sending place and a receiving place not related to each other can be used. Thus, the consumers including the sender and the receiver can enjoy the service at a nearby shop.

Unlike in the present embodiment in which the package is brought in at the sending place, the invention is applicable with equal effect to the case in which an application is filed through a personal computer or telephone at the user's home and after exchanging the required information on a network, the package can be collected by the sending place.

Further, although the person-to-person package transportation is assumed in this embodiment, the invention can be used also in the case where a gift is sent to a third party by mail order or the user or his family members make a purchase by mail order.

The information in the knowledge of the purchaser alone can be embedded in data having a small redundancy. As a result, the need is eliminated for the purchaser to carry a recording medium or a data base to be installed at the place of use to assure a sufficient network environment.

In an application of this system to tickets, the user can acquire the ticket data through an internet and print it on his own printer. In view of the ease with which the print can be duplicated, however, the purchaser information is required to be embedded by such means as electronic watermark.

In an application of the invention to the traveler's check, on the other hand, a request is given to issue a traveler's check through an internet and to deliver the traveler's check by ordinary mail. Further, the traveler's check prepared by this system is higher in security than the conventional ones (having a much less chance of being actually used even if lost or stolen), and conveniently requires no advance signature.

Furthermore, in an application to the door-to-door package delivery service, a system is provided in which the place of use cannot conduct an illegal act. It is thus possible to use a shop of low reliability as a place for positive authentication. Also, the user is not required to disclose such private information as his driver's license to the shop, nor to memorize the number of a large number of digits, nor to take trouble to change the password each time. Therefore, it is possible to provide an authentication system which exerts a lesser burden on the user.

According to the embodiments of the invention, the information for identifying the user is embedded in data having a small redundancy to identify the user without using any special recording medium.

According to the embodiments of the invention, it can be determined whether the user identity or the user's rights are legitimate or not even in a place of use where the data base of the user or a sufficient network cannot be installed.

According to the embodiments of the invention, even a shop of low reliability can be used as a place where transactions can be positively substantiated by suppressing the illegal act of the place of use itself.

What is claimed is:

1. A service issuing method for issuing the identification information required for receiving a service, to the user desirous of receiving said service, comprising the steps of:
generating said identification information in response to an application filed by said user;
encrypting said identification information by a first encryption key corresponding to a first decryption key owned by a service provider for providing said service to said user;
encrypting said encrypted identification information again by a second encryption key corresponding to a second decryption key owned by said user; and
outputting or transmitting to said user said identification information encrypted again.

2. A service issuing method according to claim 1, further comprising the steps of:
acquiring said second decryption key from selected one of said user and said service provider; and
determining whether the correspondence between said second decryption key and said second encryption key is legitimate or not.

3. A service issuing method according to claim 1,
wherein said second decryption key and said second encryption key include a password generated by said user.

4. A service issuing method according to claim 1, further comprising the step of issuing to said user the identification information encrypted again, after authentication of said user.

5. A service issuing method according to claim 1,
wherein said identification information is contained in selected one of a ticket, a traveler's check, a promissory note and a receipt.

6. A service issuing method according to claim 1,
wherein said first decryption key and said first encryption key are generated by said service provider, and said second decryption key and said second encryption key are generated by said user.

7. A service issuing system for issuing the identification information required for receiving a service, to the user desirous of receiving said service, comprising:
means for generating said identification information in response to an application filed by said user;
first encryption means for encrypting said identification information by a first encryption key corresponding to a first decryption key owned by a service provider for providing said service to said user;
second encryption means for encrypting said encrypted identification information again by a second encryption key corresponding to a second decryption key owned by said user; and
output means for outputting or transmitting to said user said identification information encrypted again.

8. A service providing method for determining whether a service is to be provided or not, in accordance with the user, comprising the steps of:
storing in a storage medium in advance, a first decryption key owned by a service provider for providing said user with said service and first identification information required to receive said service;
acquiring from said user second identification information required to receive said service and a second decryption key owned by said user;
decrypting said second identification information by said second decryption key;
decrypting again said decrypted second identification information by said first decryption key;
comparing said second identification information decrypted again with said first identification information; and
displaying and/or outputting results of said comparison.

9. A service providing system for determining whether a service is to be provided or not, in accordance with the user, comprising:
storage means for storing a first decryption key owned by a service provider for providing said user with said service and first identification information required to receive said service;
acquisition means for acquiring from said user second identification information required to receive said service and a second decryption key owned by said user;
first decryption means for decrypting said second identification information by said second decryption key;
second decryption means for decrypting again said decrypted second identification information by said first decryption key;
comparison means for comparing said second identification information decrypted again with said first identification information; and
output means for displaying and/or outputting results of said comparison.

10. A ticket issuing method for issuing a ticket in response to an application from a user, comprising the steps of:
generating identification information of said ticket;
encrypting said identification information by a first encryption key corresponding to a first decryption key owned by a ticket utilization place system for determining the legitimacy of said ticket;
encrypting again said encrypted identification information by a second encryption key corresponding to a second decryption key owned by said user; and
generating said ticket including said identification information encrypted again.

11. An issuing system for issuing a ticket in response to an application from a user, comprising:
means for generating identification information of said ticket;
first encryption means for encrypting said identification information by a first encryption key corresponding to a first decryption key owned by a ticket utilization place system for determining the legitimacy of said ticket;
second encryption means for encrypting again said encrypted identification information by a second encryption key corresponding to a second decryption key owned by said user; and
means for generating said ticket including said identification information encrypted again.

12. An issuing method for issuing selected one of a traveler's check and a promissory note in response to an application from a user, comprising the steps of:
generating identification information of selected one of said traveler's check and said promissory note;
encrypting said identification information by a first encryption key corresponding to a first decryption key owned by a financial institution for issuing selected one of said traveler's check and said promissory note, as the case may be;
encrypting said encrypted identification information again by a second encryption key corresponding to a second decryption key owned by said user; and
generating selected one of said traveler's check and said promissory note, as the case may be, including said identification information encrypted again.

13. An issuing system for issuing selected one of a traveler's check and a promissory note in response to an application from a user, comprising:
means for generating identification information of selected one of said traveler's check and said promissory note;
first encryption means for encrypting said identification information by a first encryption key corresponding to a first decryption key owned by a financial institution for issuing selected one of said traveler's check and said promissory note, as the case may be;
second encryption means for encrypting said encrypted identification information again by a second encryption key corresponding to a second decryption key owned by said user; and
means for generating selected one of said traveler's check and said promissory note, as the case may be, including said identification information encrypted again.

14. An application receiving method for receiving an application from a sender desirous of distributing selected one of a package and a mail, comprising the steps of:
acquiring receiver information on a receiver of said package or said mail;
generating identification information of said package or said mail;
calculating said identification information by a one-way function;
encrypting said calculated identification information by a first encryption key corresponding to a first decryption key owned by a receiving place system for determining legitimacy of said receiver;
notifying said receiver of said calculated identification information;
acquiring from said receiver a password generated by said receiver;
calculating said encrypted identification information by said password; and
printing or storing said identification information calculated by said password, in a tag attached to said package or said mail, as the case may be.

15. An application receiving system for receiving an application from a sender desirous of distributing selected one of a package and a mail, comprising:
acquisition means for acquiring an receiver information on the receiver of said package or said mail;
means for generating identification information of said package or said mail;
first arithmetic means for calculating said identification information by a one-way function;
encryption means for encrypting said calculated identification information by a first encryption key corresponding to a first decryption key owned by a receiving place system for determining legitimacy of said receiver;
notification means for notifying said receiver of said calculated identification information;
acquisition means for acquiring from said receiver a password generated by said receiver;
second arithmetic means for calculating said encrypted identification information by said password; and
output means for printing or storing said identification information calculated by said password, in a tag attached to said package or said mail.
